(19) United States
(12) Patent Application Publication
(10) Pub. No.: US 2025/0284076 A1
(43) Pub. Date: Sep. 11, 2025

(54) OPTICAL MODULE WITH THERMAL MANAGEMENT FOR CPO CONFIGURATION AND OPTICAL COMMUNICATION SYSTEM THEREOF

(71) Applicant: Prime World International Holdings Ltd., New Taipei City (TW)

(72) Inventors: Yu CHEN, New Taipei City (TW); Che-Shou YEH, New Taipei City (TW); Jiun Shian LI, New Taipei City (TW); Yi-Jheng WONG, New Taipei City (TW); Shih-Cheng LIN, New Taipei City (TW)

(21) Appl. No.: 18/755,110

(22) Filed: Jun. 26, 2024

(30) Foreign Application Priority Data
Mar. 8, 2024 (TW) 113108670

(51) Int. Cl. G02B 6/42

(52) U.S. Cl. CPC G02B 6/4268

(57) ABSTRACT

The present disclosure provides an optical module with CPO configuration which includes a housing, a substrate, a plurality of optical communication assemblies, and a plurality of heat dissipation components. The substrate is disposed in the housing. The plurality of optical communication assemblies are disposed on a mounting surface of the substrate. The heat dissipation components are spaced apart from each other and located between the mounting surface of the substrate and the housing, and the heat dissipation components are disposed to be corresponding to the plurality of optical communication assemblies, respectively.

### CROSS-REFERENCE TO RELATED APPLICATIONS

This non-provisional application claims priority under 35 U.S.C. § 119(a) on Patent Application No(s). 113108670 filed in Taiwan, ROC on Mar. 8, 2024, the entire contents of which are hereby incorporated by reference.

### BACKGROUND

### 1. Technical Field

This disclosure relates to an optical module with Co-Packaged Optics (CPO) configuration.

### 2. Related Art

CPO technology co-packages an electronic integrated circuit (EIC) and a photonic integrated circuit (PIC) on the same carrier. CPO technology enables optical communication assemblies to be located closer to processing chips, solving the challenges presented by small pluggable optical transceivers, including thermal management, power consumption, bandwidth, and the density of connecting ports.

However, CPO technology still presents some problems to be solved in the application of existing optical modules.

### SUMMARY

According to one aspect of the present disclosure, an optical module with CPO configuration includes a housing, a substrate, a plurality of optical communication assemblies, and a plurality of heat dissipation components. The substrate is disposed in the housing. The plurality of optical communication assemblies are disposed on a mounting surface of the substrate. The plurality of heat dissipation components are spaced apart from each other and located between the mounting surface of the substrate and the housing, and the plurality of heat dissipation components are disposed to be corresponding to the plurality of optical communication assemblies, respectively.

According to another aspect of the present disclosure, an optical communication system includes a carrier and an optical module with CPO configuration. The carrier includes an application-specific integrated circuit chip. The optical module is disposed on the carrier and in communication with the application-specific integrated circuit chip. The optical module includes a housing, a substrate, a plurality of optical communication assemblies, and a plurality of heat dissipation components. The substrate is disposed in the housing. The substrate has a mounting surface and an electrical coupling surface located opposite to each other, and the electrical coupling surface has a plurality of conductive terminals in contact with the carrier. The plurality of optical communication assemblies are disposed on the mounting surface of the substrate. The plurality of heat dissipation components are spaced apart from each other and located between the mounting surface of the substrate and the housing, and the plurality of heat dissipation components are disposed to be corresponding to the plurality of optical communication assemblies, respectively.

According to still another aspect of the present disclosure, an optical module with CPO configuration includes a housing, a substrate, a first optical communication assembly, a second optical communication assembly, a first heat dissipation component, and a second heat dissipation component. The substrate is disposed in the housing. The substrate includes a motherboard and a daughter board, each of the motherboard and the daughter board has a mounting surface, and the daughter board is disposed on the mounting surface of the motherboard. The first optical communication assembly is disposed on the mounting surface of the motherboard. The second optical communication assembly is disposed on the mounting surface of the daughter board. The first heat dissipation component is disposed between the mounting surface of the motherboard and the housing, and the first optical communication assembly is in thermal contact with the first heat dissipation component through the motherboard. At least a part of the second heat dissipation component is located between the second optical communication assembly and the housing, and the second optical communication assembly is in thermal contact with the second heat dissipation component. The motherboard has an electrical coupling surface located opposite to the mounting surface of the motherboard, and the electrical coupling surface has a plurality of conductive terminals.

### BRIEF DESCRIPTION OF THE DRAWINGS

The present disclosure will become better understood from the detailed description given hereinbelow and the accompanying drawings which are given by way of illustration only and thus are not intended to limit the present disclosure and wherein:

FIG. 1 is a perspective view of an optical module according to one embodiment of the present disclosure;

FIG. 2 is a perspective view of the optical module in FIG. 1 from another viewing angle;

FIG. 3 is an exploded view of the optical module in FIG. 1;

FIG. 4 is a side view of the optical module in FIG. 3;

FIGS. 5 to 7 are schematic views of a heat dissipating path of the optical module in FIG. 4;

FIG. 8 is a perspective view showing that an internal optical fiber of the optical module crosses the heat dissipation components in FIG. 4; and

FIG. 9 is a schematic view of an optical communication system according to one embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

With the increasing demand for higher transmission rates such as 1.6 Tbps, 3.2 Tbps, or even 6.4 Tbps, CPO technology is regarded as a promising solution and draws significant attention. Currently, Optical Internetworking Forum (OIF) has defined a Co-Packaging Framework for CPO to be compatible with optical internet products all over the world. In compliance with Co-Packaging Framework defined by OIF, one of the current problems to be solved in the relevant industry is to provide optical modules that can be configured with more active components for optical communication without making too much thermal consumption compromise.

According to an optical module in one embodiment of the present disclosure, a plurality of heat dissipation components are disposed between the mounting surface of the substrate and the housing, which shares the thermal loads created by the plurality of heat dissipation components in the optical module with CPO configuration, thereby preventing heat from accumulating in any heat dissipation component.

Some or all of the technical features disclosed in one or more embodiments of the present disclosure may be combined to achieve corresponding effects.

The term “couple” or “coupled to” refers to any connection, link, or the like. Moreover, the term “optically couple” or “optically coupled to” refers to a relationship where light is transmitted (imparted) from a device to another. Unless otherwise specified, devices that “couple” or “coupled to” each other do not need to be directly connected to each other and may be separated by intervening objects.

The term “at least one of A and B” used herein, unless otherwise specified or clearly understood from the context, may encompass “only A”, “only B” or “both A and B”. Similarly, the term “at least one of A, B and C” used herein may encompass “only A”, “only B”, “only C”, “both A and B”, “both B and C”, “both A and C” or “all of A, B and C”.

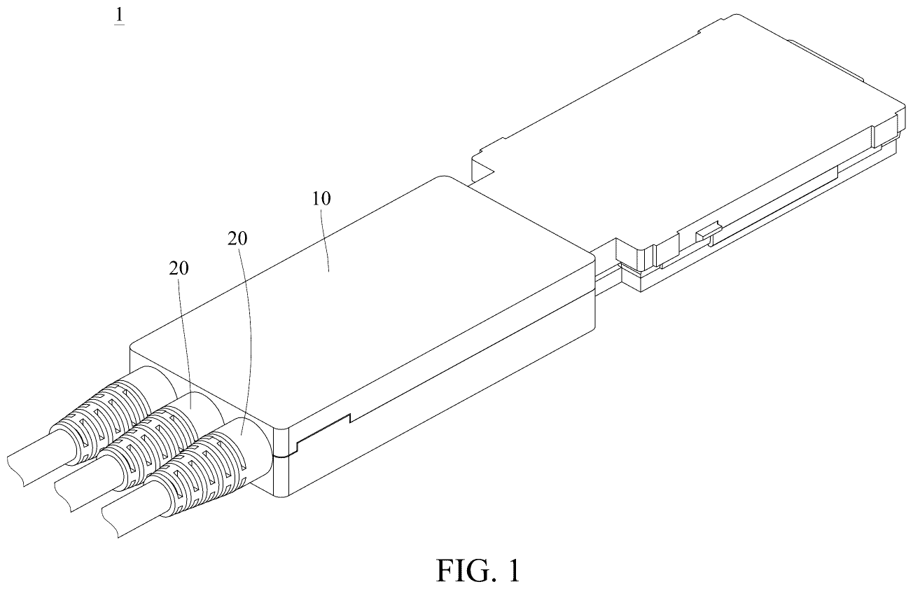

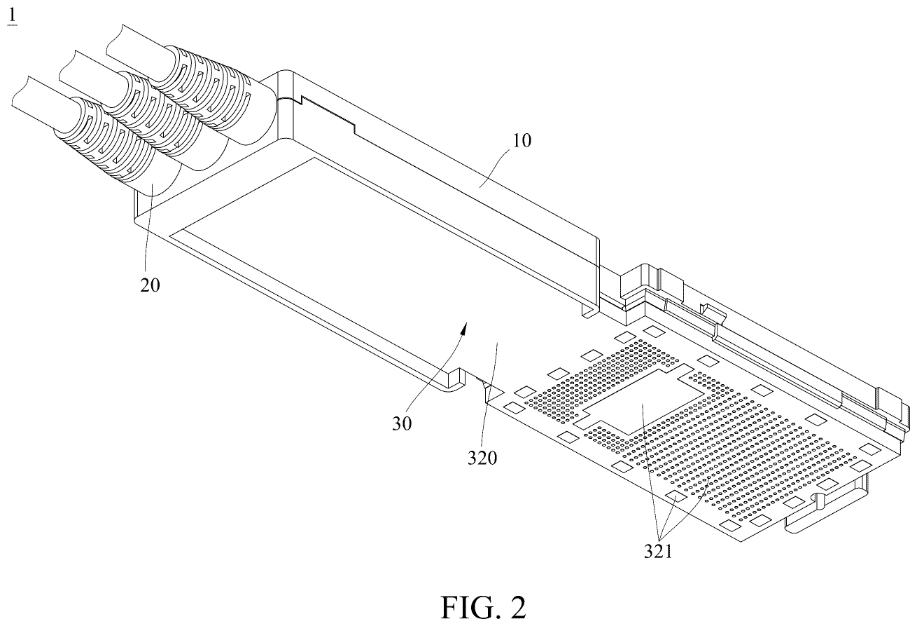

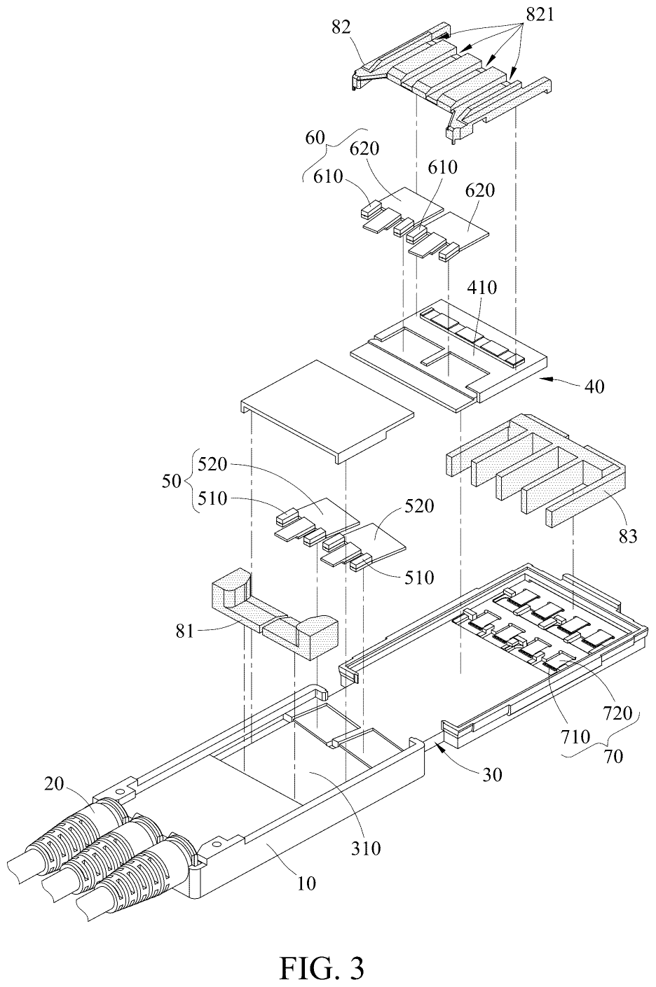

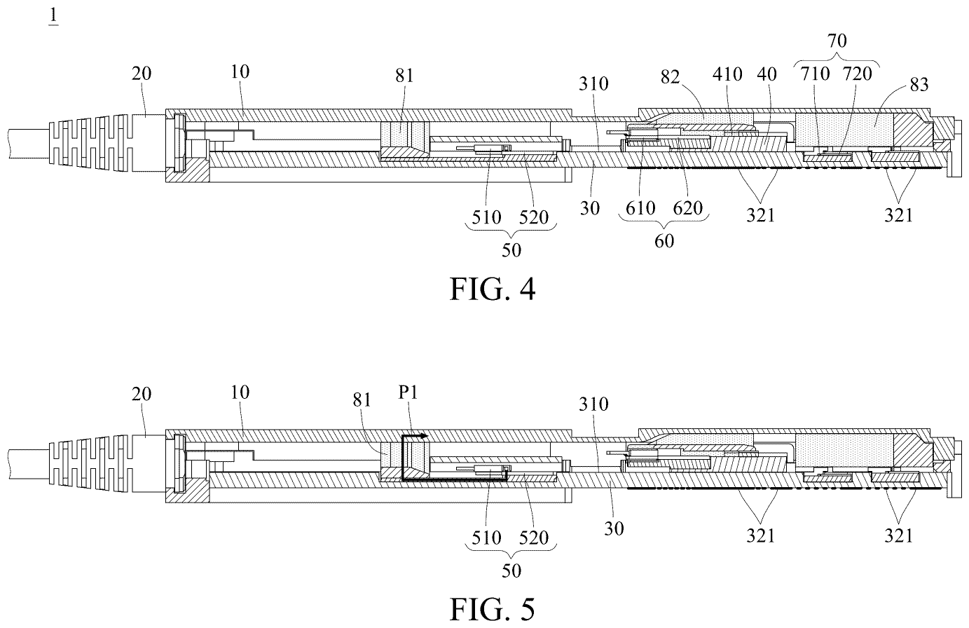

Please refer to FIGS. 1 to 4. FIG. 1 is a perspective view of an optical module 1 according to one embodiment of the present disclosure, FIG. 2 is a perspective view of the optical module 1 in FIG. 1 from another viewing angle, FIG. 3 is an exploded view of the optical module 1 in FIG. 1, and FIG. 4 is a side view of the optical module 1 in FIG. 3. In this embodiment, the optical module 1 may include a housing 10, an optical coupler 20, a substrate, optical communication assemblies 50-70, and a plurality of internal optical fibers (not shown). The optical module 1 may be understood as an optical transceiver.

The housing 10 may be a housing adapted to CPO configuration determined by OIF. Besides, the housing 10 may be made of a metal material. The housing 10 may be a housing integrally formed as a single piece or include an upper housing and a lower housing assembled to each other.

The optical coupler 20 may be disposed within an accommodation space defined by the housing 10. Further, at least a part of the optical coupler 20 may extrude out of the accommodation space. One end of the internal optical fiber may be optically coupled to the optical coupler 20. The optical coupler 20 may be understood as an optical fiber connector or an active optical cable (AOC). FIGS. 1 to 3 exemplarily illustrate that the optical module 1 includes three optical couplers 20, but the number of the optical couplers 20 is not intended to limit the present disclosure.

The substrate may be understood as a single printed circuit board assembly (PCBA) or a combination of PCBAs. In this embodiment, the substrate may include a motherboard 30 and a daughter board 40 which are two independent or separate PCBAs. The motherboard 30 and the daughter board 40 may be accommodated in the housing 10, and the daughter board 40 may be disposed on the mounting surface 310 of the motherboard 30. Further, the mounting surface 310 may be a top surface of the motherboard 30. And that the daughter board 40 is disposed on the top surface of the motherboard 30 may realize the electrical connection between circuits of the daughter board 40 and circuits of the motherboard 30. Besides, the daughter board 40 may have a mounting surface 410 facing the same direction along with the mounting surface 310. In one implementation, the mounting surface 410 may be a top surface of the daughter board 40. The combination of the mounting surfaces 310 and 410 herein may be understood as the mounting surface of the substrate. In other embodiments where the substrate is a single PCBA, the top surface of the single PCBA may be understood as the mounting surface of the substrate.

The optical communication assembly 50 may be disposed on the mounting surface 310 of the motherboard 30. The optical communication assembly 50 may include an optical communication unit 510 and an electronic component 520. For example, the optical communication unit 510 may be a laser diode, and the electronic component 520 may be a driving chip. Further, the electronic component 520 may be understood as a PIC. The optical communication assembly 50 may further include an optical modulator, a wavelength division multiplexer, a collimating lens and/or a digital signal processor (DSP). FIG. 3 exemplarily illustrates two optical communication assemblies 50, and each of the optical communication assemblies 50 includes two optical communication units 510. However, the number of the optical communication assemblies 50 is not intended to limit the present disclosure.

The optical communication assembly 60 may be disposed on the mounting surface 410 of the daughter board 40. The optical communication assembly 60 may include an optical communication unit 610 and an electronic component 620. For example, the optical communication unit 610 may be a laser diode, and the electronic component 620 may be a driving chip. Further, the electronic component 620 may be understood as a PIC. The optical communication assembly 60 may further include an optical modulator, a wavelength division multiplexer, a collimating lens and/or a DSP. FIG. 3 exemplarily illustrates two optical communication assemblies 60, and each of the optical communication assemblies 60 includes two optical communication units 610. However, the number of the optical communication assemblies 60 is not intended to limit the present disclosure.

The optical communication assembly 70 may be disposed on the mounting surface 310 of the motherboard 30. The optical communication assembly 70 may include an optical communication unit 710 and an electronic component 720. For example, the optical communication unit 710 may be a photodiode, and the electronic component 720 may be a transimpedance amplifier. Further, the electronic component 720 may be understood as a EIC. The optical communication assembly 70 may further include a wavelength division demultiplexer and/or a DSP. FIG. 3 exemplarily illustrates eight optical communication assemblies 70, and each of the optical communication assemblies 70 includes four optical communication units 710. However, the number of the optical communication assemblies 70 is not intended to limit the present disclosure.

In some embodiments, the optical communication unit 510 of the optical communication assembly 50 may be a photodiode, and the electronic component 520 may be a transimpedance amplifier. In some embodiments, the optical communication unit 610 of the optical communication assembly 60 may be a photodiode, and the electronic component 520 may be a transimpedance amplifier. In some embodiments, the optical communication unit 710 of the optical communication assembly 70 may be a laser diode, and the electronic component 720 may be a driving chip.

In some embodiments, the optical module 1 may not include the optical communication assembly 50 or the optical communication assembly 60 as shown in FIG. 1. In some embodiments, the optical module 1 may merely include the optical communication assembly 70 without the optical communication assembly 50 and the optical communication assembly 60 as shown in FIG. 1.

In some embodiments, the optical communication assemblies 50 and 60 may be understood as a transmitter optical sub-assembly (TOSA). In some embodiments, the optical communication assembly 70 may be understood as a receiver optical sub-assembly (ROSA).

The internal optical fiber may be understood as a pigtail, a ribbon cable or a jumper disposed in the housing 10 for optically coupling the optical communication assembly 50 and the corresponding optical coupler 20, optically coupling the optical communication assembly 60 and the corresponding optical coupler 20, and optically coupling the optical communication assembly 70 and the corresponding optical coupler 20. In one embodiment, the internal optical fiber may be disposed within an accommodation space defined by the housing 10. In one embodiment, the internal optical fiber may be disposed between the substrate and the housing 10.

An optical signal generated by the optical communication assembly 50 may be transmitted to an external optical fiber via the internal optical fiber and the corresponding optical coupler 20. An optical signal generated by the optical communication assembly 60 may be transmitted to an external optical fiber via the internal optical fiber and the corresponding optical coupler 20. The optical signal transmitted by the external optical fiber may be received by the optical communication assembly 70 via the corresponding optical coupler 20 and the internal optical fiber. The internal optical fiber optically coupled to the optical communication assembly 70 may be included in a bent optical fiber array.

According to one embodiment of the present disclosure, the optical communication assembly 60 may be located farther away from the optical couplers 20 than the optical communication assembly 50, and the optical communication assembly 70 may be located farther away from the optical couplers 20 than the optical communication assembly 60. More specifically, the optical communication assembly 50, the optical communication assembly 60, and the optical communication assembly 70 are sequentially arranged from the optical couplers 20 along a lengthwise direction of the optical module 1.

According to one embodiment of the present disclosure, the substrate may have an electrical coupling surface located opposite to the mounting surface. As shown in FIG. 2, the motherboard 30 may have an electrical coupling surface 320 located opposite to the mounting surfaces 310 and 410. The electrical coupling surface 320 may be understood as a bottom surface of the motherboard 30 or the substrate. The electrical coupling surface 320 may have a plurality of conductive terminals 321, and each of the conductive terminals 321 may be understood as an exposed metal pad or a metal pin formed on the bottom surface of the motherboard 30. The conductive terminal 321 is configured to electrically connect the optical communication assemblies 50, 60, and 70 and external circuits, which will be further explained later.

According to one embodiment of the present disclosure, the optical module 1 may further include a plurality of heat dissipation components. As shown in FIG. 3 and FIG. 4, the optical module 1 may include heat dissipation components 81-83. The heat dissipation components 81, 82, and 83 may be spaced apart from one another and located between the mounting surface 310 of the motherboard 30 and the housing 10. The heat dissipation component 81 may be disposed to be corresponding to the optical communication assembly 50, the heat dissipation component 82 may be disposed to be corresponding to the optical communication assembly 60, and the heat dissipation component 83 may be disposed to be corresponding to the optical communication assembly 70. FIG. 3 and FIG. 4 exemplarily illustrate that the optical module 1 includes three heat dissipation components, but the specific number of the heat dissipation components is not limited thereto. Each of the heat dissipation components may be understood as a metal component, or a combination of a metal component and a thermal pad. The metal component may be understood as metal blocks processed by a cutting process or metal sheets processed by a stamping process.

According to one embodiment of the present disclosure, an orthogonal projection of at least one of the heat dissipation components 81, 82, and 83 onto the electrical coupling surface 320 may overlap at least some of the conductive terminals 321. As shown in FIG. 2 and FIG. 4, an orthogonal projection of each of the heat dissipation component 82 and the heat dissipation component 83 onto the electrical coupling surface 320 may overlap some of the conductive terminals 321. FIG. 4 exemplarily illustrates that the orthogonal projections of the heat dissipation components 82 and 83 onto the electrical coupling surface 320 may overlap the conductive terminal 321, and the orthogonal projection of the heat dissipation component 81 onto the electrical coupling surface 320 may not overlap the conductive terminal 321. However, the present disclosure is not limited thereto. In some embodiments, the orthogonal projection of the heat dissipation component 83 onto the electrical coupling surface 320 may overlap the conductive terminal 321, and the orthogonal projections of the heat dissipation components 81 and 82 onto the electrical coupling surface 320 may not overlap any conductive terminal 321. In one embodiment, the distribution of the conductive terminals 321 may comply with the design specification for CPO.

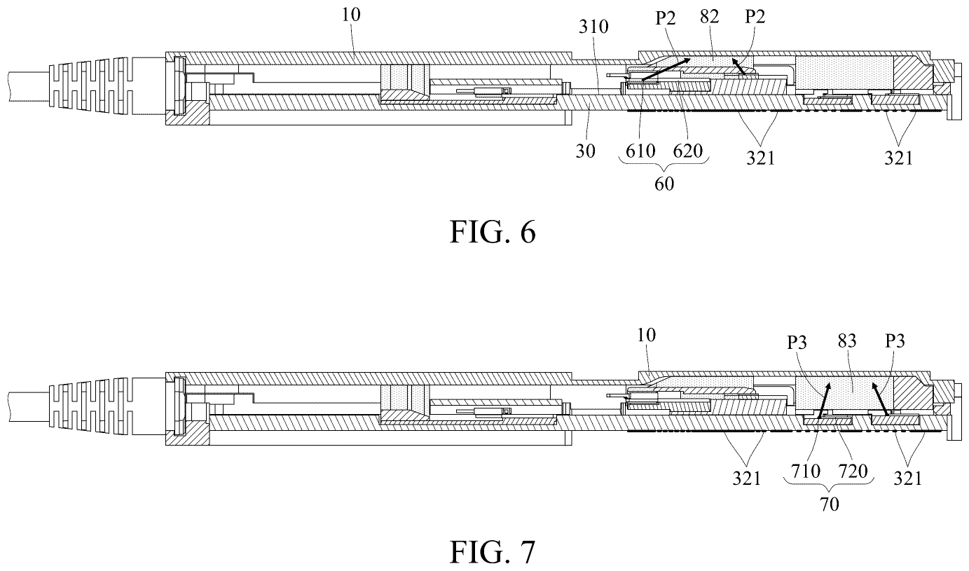

According to one embodiment of the present disclosure, the optical communication assembly 50 may be in thermal contact with the heat dissipation component 81 through the substrate. Further, please refer to FIG. 5. FIG. 5 illustrates a schematic view of a heat dissipating path associated with the optical communication assembly 50. The heat dissipation component 81 is disposed between the mounting surface 310 of the motherboard 30 and the housing 10, and the heat dissipation component 81 may be located between the optical coupler 20 and the optical communication assembly 50 in the lengthwise direction of the optical module 1. The mounting surface 310 of the motherboard 30 can be formed with a copper pour that facilitates the heat conduction, and a part of the optical communication assembly 50 may be in contact with the copper pour. The optical communication assembly 50 may generate heat during operation. For example, at least one of said elements (laser diode and driving chip) in the optical communication assembly 50 may generate heat. The heat may be transferred to an upper half part of the housing 10 via motherboard 30 and the heat dissipation component 81. Further, a certain amount of the heat may be transferred to the upper half part of the housing 10 via the heat dissipation component 81 as shown in a thermal transfer path P1 in FIG. 5.

According to one embodiment of the present disclosure, the optical communication assembly 60 may be in thermal contact with the heat dissipation component 82. Further, please refer to FIG. 6. FIG. 6 illustrates a schematic view of a heat dissipating path associated with the optical communication assembly 60. The heat dissipation component 82 is disposed between the mounting surface 310 of the motherboard 30 and the housing 10, and at least a part of the heat dissipation component 82 is located between the mounting surface 410 of the daughter board 40 and the housing 10. More specifically, the heat dissipation component 82 may extend into an air gap between the housing 10 and the optical communication assembly 60. A bottom part of the heat dissipation component 82 may be in thermal contact with at least one of the optical communication unit 610 and the electronic component 620 of the optical communication assembly 60, and a top part of the heat dissipation component 82 may be in thermal contact with an inner side surface of the housing 10. The optical communication assembly 60 may generate heat during operation. For example, at least one of the laser diode and the driving chip in the optical communication assembly 60 may generate heat. The heat may be transferred to the upper half part of the housing 10 via the heat dissipation component 82. Further, a certain amount of the heat will be transferred to the upper half part of the housing 10 via the heat dissipation component 82 as shown in a thermal transfer path P2 in FIG. 6.

According to one embodiment of the present disclosure, the optical communication assembly 70 may be in thermal contact with the heat dissipation component 83. Further, please refer to FIG. 7. FIG. 7 illustrates a schematic view of a heat dissipating path associated with the optical communication assembly 70. The heat dissipation component 83 is disposed between the mounting surface 310 of the motherboard 30 and the housing 10, and at least a part of the heat dissipation component 83 may be located between the housing 10 and the optical communication assembly 70. A bottom part of the heat dissipation component 83 may be in thermal contact with at least one of the optical communication unit 710 and the electronic component 720 of the optical communication assembly 70, and a top part of the heat dissipation component 83 may be in thermal contact with the inner side surface of the housing 10. The optical communication assembly 70 may generate heat during operation. For example, at least one of the transimpedance amplifier and the DSP in the optical communication assembly 70 may generate heat. The heat may be transferred to the upper half part of the housing 10 via the heat dissipation component 83. Further, a certain amount of the heat will be transferred to the upper half part of the housing 10 via the heat dissipation component 83 as shown in a thermal transfer path P3 in FIG. 7.

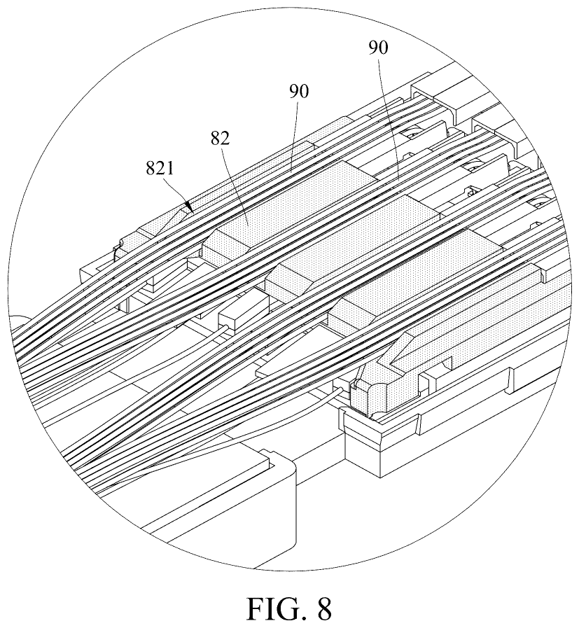

According to one embodiment of the present disclosure, the internal optical fiber of the optical module 1 may cross the heat dissipation component 82. Please refer to FIG. 4 and FIG. 8 together. FIG. 8 is a perspective view showing that an internal optical fiber 90 of the optical module 1 crosses the heat dissipation components in FIG. 4. The internal optical fiber 90 optically coupling the optical communication assembly 70 and the corresponding optical coupler 20 may cross the heat dissipation component 82. Further, the heat dissipation component 82 may have a groove 821, and the internal optical fiber 90 may be accommodated in the groove 821. FIG. 3 and FIG. 8 exemplarily illustrate that the heat dissipation component 82 has four grooves 821 accommodating four internal optical fibers 90 that are ribbon fiber optic cables, respectively. However, the number of the grooves 821 is not intended to limit the present disclosure.

According to one embodiment of the present disclosure, in addition to the aforesaid heat dissipation components 81, 82, and 83, the optical module 1 may further include a fourth heat dissipation component (not shown). The fourth heat dissipation component may be disposed on the mounting surface 310 of the motherboard 30 and located between the heat dissipation component 81 and the heat dissipation component 82. The fourth heat dissipation component may be in thermal contact with a heat source (e.g., a microprocessor or a circuit layout configured to provide a driving current to the optical communication assembly) disposed on the mounting surface 310.

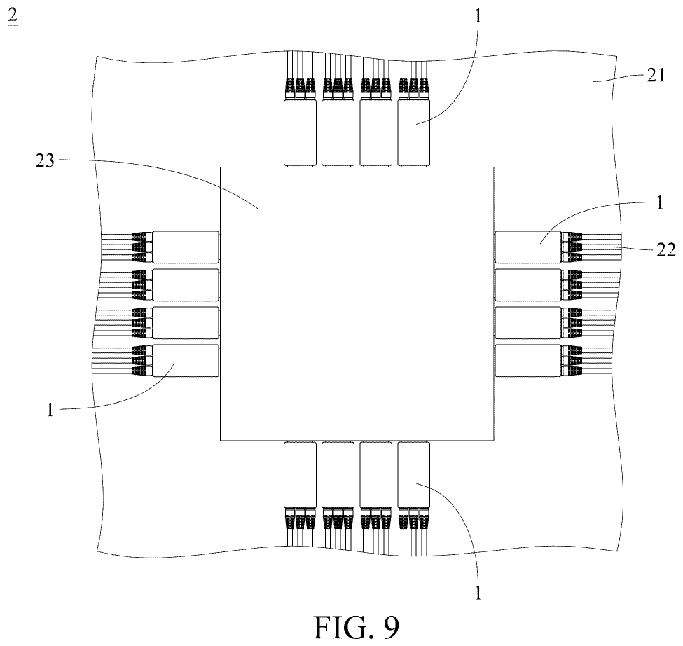

FIG. 9 is a schematic view of an optical communication system 2 according to one embodiment of the present disclosure. The optical communication system 2 having CPO configuration may include the optical module 1 as shown in FIG. 1, and the optical module 1 may be fixed onto the carrier 21 including an application-specific integrated circuit (ASIC) chip 23. An optical port of the optical module 1 may be adapted to the external optical fiber 22, and an electrical port of the optical module 1 may be electrically connected to the ASIC chip 23. FIG. 9 exemplarily illustrates that the optical communication system 2 includes a total of sixteen optical modules 1, where each of the optical modules 1 may have a signal transmission rate of 3.2 Tbps, and the application-specific integrated circuit chip 23 may have a signal transmission rate of 51.2 Tbps. Further, please refer to FIG. 2, the conductive terminal 321 of the electrical coupling surface 320 of the motherboard 30 may be in contact with the carrier 21. More specifically, the optical communication assemblies 50, 60, and 70 of the optical module 1 may be electrically connected to the ASIC chip 23 via the conductive terminal 321 and the carrier 21.

In CPO configuration, since the substrate (motherboard 30) needs to be in direct contact with the carrier 21, a heat dissipation component cannot be disposed under the substrate. As a result, the heat generated by the optical component or the electronic component cannot be transferred to the upper half part (e.g., upper housing part) of the housing 10 via a lower half part of the housing 10 (e.g., lower housing part), resulting a serious heat accumulation. According to one embodiment of the present disclosure, a plurality of heat dissipation components 81, 82, and 83 are disposed between the mounting surface 310 of the substrate and the housing 10, which shares the thermal loads created by the plurality of heat dissipation components, thereby preventing heat from accumulating in any heat dissipation component.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An optical module with Co-Packaged Optics (CPO) configuration, comprising:
a housing;
a substrate, disposed in the housing;
a plurality of optical communication assemblies, disposed on a mounting surface of the substrate; and
a plurality of heat dissipation components, spaced apart from each other and located between the mounting surface of the substrate and the housing, wherein the plurality of heat dissipation components are disposed to be corresponding to the plurality of optical communication assemblies, respectively.

2. The optical module with CPO configuration according to claim 1, wherein an electrical coupling surface of the substrate is located opposite to the mounting surface, and the electrical coupling surface has a plurality of conductive terminals.

3. The optical module with CPO configuration according to claim 2, wherein an orthogonal projection of at least one of the plurality of heat dissipation components onto the electrical coupling surface overlaps at least some of the plurality of conductive terminals.

4. The optical module with CPO configuration according to claim 1, further comprising an optical coupler disposed within an accommodation space defined by the housing, wherein the plurality of optical communication assemblies comprise a first optical communication assembly, a second optical communication assembly, and a third optical communication assembly, the second optical communication assembly is located farther away from the optical coupler than the first optical communication assembly, the third optical communication assembly is located farther away from the optical coupler than the second optical communication assembly, and the plurality of heat dissipation components are disposed to be corresponding to the first optical communication assembly, the second optical communication assembly, and the third optical communication assembly, respectively.

5. The optical module with CPO configuration according to claim 4, wherein each of the first optical communication assembly and the second optical communication assembly is a Transmitter Optical Sub-Assembly, and the third optical communication assembly is a Receiver Optical Sub-Assembly.

6. The optical module with CPO configuration according to claim 4, wherein the plurality of heat dissipation components comprise a first heat dissipation component located between the optical coupler and the first optical communication assembly, and the first optical communication assembly is in thermal contact with the first heat dissipation component through the substrate.

7. The optical module with CPO configuration according to claim 4, wherein the plurality of heat dissipation components comprise a second heat dissipation component, at least a part of the second heat dissipation component is located between the housing and the second optical communication assembly, and the second optical communication assembly is in thermal contact with the second heat dissipation component.

8. The optical module with CPO configuration according to claim 7, wherein the substrate comprises a motherboard and a daughter board, the mounting surface is located on each of the motherboard and the daughter board, the daughter board is disposed on the mounting surface of the motherboard, the first optical communication assembly and the third optical communication assembly are disposed on the mounting surface of the motherboard, the second optical communication assembly is disposed on the mounting surface of the daughter board, the second heat dissipation component is disposed on the mounting surface of the motherboard and extends into an air gap between the housing and the mounting surface of the daughter board.

9. The optical module with CPO configuration according to claim 7, further comprising an optical fiber optically coupling the third optical communication assembly and the optical coupler, wherein the optical fiber crosses the second heat dissipation component.

10. The optical module with CPO configuration according to claim 9, wherein the second heat dissipation component has a groove, and the optical fiber is disposed in the groove.

11. The optical module with CPO configuration according to claim 4, wherein the plurality of heat dissipation components comprise a third heat dissipation component, at least a part of the third heat dissipation component is located between the housing and the third optical communication assembly, and the third optical communication assembly is in thermal contact with the third heat dissipation component.

12. An optical communication system, comprising:
a carrier, comprising an application-specific integrated circuit chip; and
an optical module with CPO configuration, disposed on the carrier and in communication with the application-specific integrated circuit chip, wherein the optical module comprises:
a housing;
a substrate, disposed in the housing, wherein the substrate has a mounting surface and an electrical coupling surface located opposite to each other, and the electrical coupling surface has a plurality of conductive terminals in contact with the carrier;
a plurality of optical communication assemblies, disposed on the mounting surface of the substrate; and
a plurality of heat dissipation components, spaced apart from each other and located between the mounting surface of the substrate and the housing, wherein the plurality of heat dissipation components are disposed to be corresponding to the plurality of optical communication assemblies.

13. The optical communication system according to claim 12, wherein a part of at least one of the plurality of heat dissipation components is located between the housing and the corresponding optical communication assembly.

14. The optical communication system according to claim 12, wherein an orthogonal projection of at least one of the plurality of heat dissipation components onto the electrical coupling surface overlaps at least some of the plurality of conductive terminals.

15. An optical module with CPO configuration, comprising:
a housing;
a substrate, disposed in the housing, wherein the substrate comprises a motherboard and a daughter board, each of the motherboard and the daughter board has a mounting surface, and the daughter board is disposed on the mounting surface of the motherboard;
a first optical communication assembly, disposed on the mounting surface of the motherboard;
a second optical communication assembly, disposed on the mounting surface of the daughter board;
a first heat dissipation component, disposed between the mounting surface of the motherboard and the housing, wherein the first optical communication assembly is in thermal contact with the first heat dissipation component through the motherboard; and
a second heat dissipation component, wherein at least a part of the second heat dissipation component is located between the second optical communication assembly and the housing, and the second optical communication assembly is in thermal contact with the second heat dissipation component;
wherein, the motherboard has an electrical coupling surface located opposite to the mounting surface of the motherboard, and the electrical coupling surface has a plurality of conductive terminals.

16. The optical module with CPO configuration according to claim 15, wherein an orthogonal projection of at least one of the first heat dissipation component and the second heat dissipation component onto the electrical coupling surface overlaps at least some of the plurality of conductive terminals.

17. The optical module with CPO configuration according to claim 15, wherein each of the first optical communication assembly and the second optical communication assembly is a Transmitter Optical Sub-Assembly.

18. The optical module with CPO configuration according to claim 15, further comprising an optical fiber disposed between the substrate and the housing.
